(19) United States
(12) Patent Application Publication
(10) Pub. No.: US 2026/0300078 A1
(43) Pub. Date: Oct. 1, 2026

(54) MANAGING PROACTIVE DIAGNOSTIC OPERATIONS AT AN INFORMATION HANDLING SYSTEM

(71) Applicant: Dell Products L.P., Round Rock, TX (US)

(72) Inventors: Laxmi Lavanya Medicherla, Georgetown, TX (US); Ibrahim Sayyed, Georgetown, TX (US); Alan Helmy Abdelhalim, Pflugerville, TX (US); Anand Prakash Joshi, Round Rock, TX (US)

(21) Appl. No.: 19/089,885

(22) Filed: Mar. 25, 2025

(51) Int. Cl. G06F 11/07; G06F 8/65; G06F 11/14

(52) U.S. Cl. CPC G06F 11/0793; G06F 8/65; G06F 11/1446

(57) ABSTRACT

Managing proactive diagnostic operations at an information handling system, including applying an update to a computing commodity; in response to applying the update: identifying previous results of a previous diagnostic test performed at the computing commodity; performing, after applying the update to the computing commodity, a current diagnostic test at the computing commodity; comparing current results of the current diagnostic test at the computing commodity to the previous results of the previous diagnostic test at the computing commodity; determining that the computing commodity failed the current diagnostic test, and in response: performing a remediation action at the computing commodity; performing a further diagnostic test at the computing commodity; comparing further results of the further diagnostic test at the computing commodity to the previous results of the previous diagnostic test at the computing commodity; determining that the computing commodity passed the further diagnostic test, and in response: enabling the computing commodity.

### BACKGROUND

### Field of the Disclosure

The disclosure relates generally to an information handling system, and in particular, managing proactive diagnostic operations at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Updating an information handling system's operating system (OS) ensures it has the latest security patches and features, enhancing performance and protection. BIOS updates can improve hardware compatibility and system stability, often addressing bugs or adding new functionalities. Firmware updates for devices like printers or routers can fix issues and improve performance. Regular software updates keep applications running smoothly and securely, preventing vulnerabilities and enhancing user experience.

### SUMMARY

Innovative aspects of the subject matter described in this specification may be embodied in a method of managing proactive diagnostic operations at an information handling system, including receiving an update to a computing commodity of the information handling system; applying the update to the computing commodity of the information handling system; in response to applying the update and without user input: identifying previous results of a previous diagnostic test performed at the computing commodity; performing, after applying the update to the computing commodity, a current diagnostic test at the computing commodity; comparing current results of the current diagnostic test at the computing commodity to the previous results of the previous diagnostic test at the computing commodity; determining, based on the comparing, that the computing commodity failed the current diagnostic test, and in response: performing, without user input, a remediation action at the computing commodity; after performing the remediation action at the computing commodity, performing a further diagnostic test at the computing commodity; comparing further results of the further diagnostic test at the computing commodity to the previous results of the previous diagnostic test at the computing commodity; determining, based on the comparing, that the computing commodity passed the further diagnostic test, and in response: enabling the computing commodity at the information handling system.

Other embodiments of these aspects include corresponding systems, apparatus, and computer programs, configured to perform the actions of the methods, encoded on computer storage devices.

These and other embodiments may each optionally include one or more of the following features. For instance, in response to determining that the computing commodity passed the further diagnostic test: uploading, to a server information handling system, a current state of the computing commodity and the remediation action performed at the computing commodity. The previous diagnostic test, the current diagnostic test, and the further diagnostic test are the same diagnostic test. The computing commodity is the basic input/output system (BIOS) of the information handling system, wherein the update to the computing commodity is an update to a version of the BIOS, wherein performing the remediation action further includes reverting the BIOS to a previous version. The computing commodity is the operating system (OS) of the information handling system, wherein the update to the computing commodity is an update to a version of the OS, wherein performing the remediation action further includes reverting the OS to a previous version. The computing commodity is computing hardware of the information handling system, wherein the update to the computing commodity is an update to a driver of the computing hardware, wherein performing the remediation action further includes reverting the driver of the computing hardware to a previous version. The computing commodity is a computer-executable application of the information handling system, wherein the update to the computing commodity is an update to a version of the computer-executable application, wherein performing the remediation action further includes reverting the computer-executable application to a previous version. The computing commodity is an external computing device of the information handling system, wherein the update to the computing commodity is an update to firmware of the external computing device, wherein performing the remediation action further includes reverting the firmware to a previous version. Determining, based on the comparing, that the computing commodity passed the current diagnostic test, and in response: enabling the computing commodity at the information handling system; and uploading, to a server information handling system, a current state of the computing commodity.

Particular implementations of the subject matter described in this specification can be implemented so as to realize one or more of the following advantages. For example, proactively running diagnostics ensures that issues caused by background updates are detected and repaired before the user encounters any problems to maintain system functionality seamlessly; automatic detection and resolution significantly enhance customer satisfaction and reduce support call volumes by addressing issues promptly and efficiently.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing proactive diagnostic operations.

FIG. 3 illustrates a method for managing proactive diagnostic operations at an information handling system.

### DESCRIPTION OF PARTICULAR EMBODIMENT(S)

This disclosure discusses methods and systems for managing proactive diagnostic operations of an information handling system. In short, when the information handling system installs an update for the BIOS, OS, a driver, or a device firmware, it may cause a driver to malfunction or a device to be disabled. The present invention addresses such by tracking updates to detect and isolate issues immediately, potentially initiating a rollback to resolve them. In short, proactive diagnostics run in the background upon detecting any update, automatically checking for regressions and flagging them before other system variables changes; and automatic remediation attempts for any failures can be configured by policy, including rollback to the latest OS restore point, previous BIOS version, or previous driver version, or updating more drivers if needed.

Specifically, this disclosure discusses a system and a method for managing proactive diagnostic operations at an information handling system, the method including receiving an update to a computing commodity of the information handling system; applying the update to the computing commodity of the information handling system; in response to applying the update and without user input: identifying previous results of a previous diagnostic test performed at the computing commodity; performing, after applying the update to the computing commodity, a current diagnostic test at the computing commodity; comparing current results of the current diagnostic test at the computing commodity to the previous results of the previous diagnostic test at the computing commodity; determining, based on the comparing, that the computing commodity failed the current diagnostic test, and in response: performing, without user input, a remediation action at the computing commodity; after performing the remediation action at the computing commodity, performing a further diagnostic test at the computing commodity; comparing further results of the further diagnostic test at the computing commodity to the previous results of the previous diagnostic test at the computing commodity; determining, based on the comparing, that the computing commodity passed the further diagnostic test, and in response: enabling the computing commodity at the information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

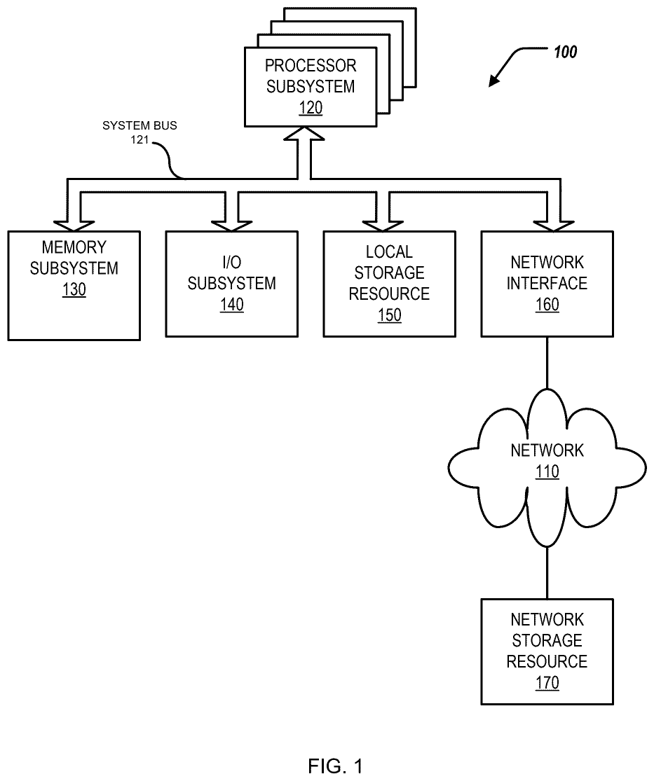

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

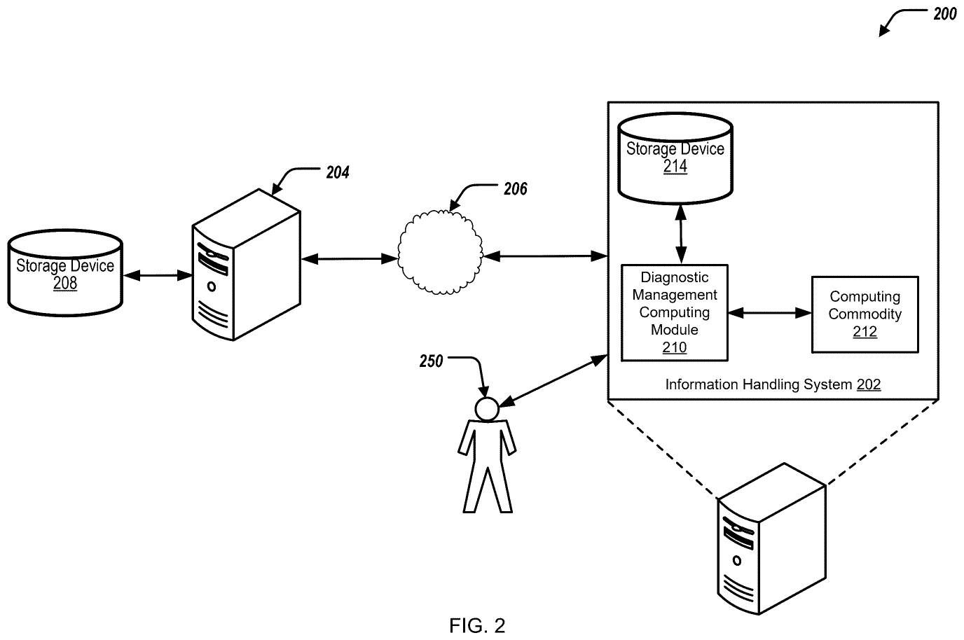

Turning to FIG. 2, FIG. 2 illustrates an environment 200 including an information handling system 202, a server information handling system 204, a network 206, and a storage device 208. The information handling system 202 can include a diagnostic management computing module 210, a computing commodity 212, and a storage device 214. In some examples, the information handling system 202 is similar to, or includes, the information handling system 100 of FIG. 1.

The information handling system 202 can be in communication with the server information handling system 204 through the network 206 (e.g., the “Internet”). The server information handling system 204 can be in communication with the storage device 208.

The diagnostic management computing module 210 can be in communication with the computing commodity 212 and the storage device 214.

The computing commodity 212 can represent any commodity of the information handling system 202, such as the basic input/output system (BIOS), the operating system (OS), computing hardware, external computing devices, or a computer-executable application.

In some examples, when the computing commodity 212 represents the OS, the computing commodity 212 can include the OS of the information handling system 202, or be a representation of the OS of the information handling system 202. In some examples, the computing commodity 212 can indicate values of metrics or parameters of the OS of the information handling system 202. In some examples, the computing commodity 212 is the OS of the information handling system 202. In some examples, the computing commodity 212 can be in communication with the OS of the information handling system 202. In some examples, the computing commodity 212 can include data associated with the OS of the information handling system 202.

In some examples, when the computing commodity 212 represents the BIOS, the computing commodity 212 can include the BIOS of the information handling system 202, or be a representation of the BIOS of the information handling system 202. In some examples, the computing commodity 212 can indicate values of metrics or parameters of the BIOS of the information handling system 202. In some examples, the computing commodity 212 is the BIOS of the information handling system 202. In some examples, the computing commodity 212 can be in communication with the BIOS of the information handling system 202.

In some examples, when the computing commodity 212 represents the computer-executable application, the computing commodity 212 can include a computer-implemented application (or computer-executable application, or computer software, or computer-executable software), or be a representation of the computer-implemented application.

In some examples, when the computing commodity 212 represents the computing hardware, the computing hardware can include memory, storage devices, video cards, audio cards, processors, and the like.

In some examples, when the computing commodity 212 represents the external computing device, the external computing device can include a docking station, keyboard, mouse, and the like.

In short, when the information handling system 202 installs an update for the BIOS, OS, a driver, or device firmware it may cause a driver to malfunction or a device to be disabled. The present invention addresses such by tracking updates to detect and isolate issues immediately, potentially initiating a rollback to resolve them. In short, proactive diagnostics run in the background upon detecting any update, automatically checking for regressions and flagging them before other system variables changes; and automatic remediation attempts for any failures can be configured by policy, including rollback to the latest OS restore point, previous BIOS version, or previous driver version, or updating more drivers if needed.

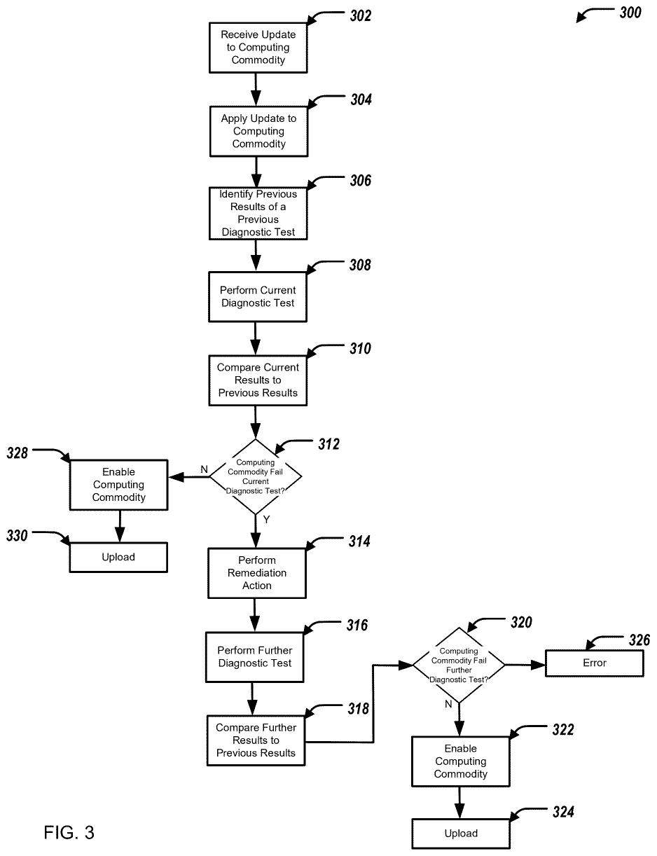

FIG. 3 illustrates a flowchart depicting selected elements of an embodiment of a method 300 for managing proactive diagnostic operations. The method 300 may be performed by the information handling system 100, the information handling system 202, and/or the diagnostic management computing module 210, and with reference to FIGS. 1-2. It is noted that certain operations described in method 300 may be optional or may be rearranged in different embodiments.

The diagnostic management computing module 210 receives an update to the computing commodity 212, at 302. The diagnostic management computing module 210 receives the update from the server information handling system 204 over the network 206. The diagnostic management computing module 210 can receive the update automatically, or in response to a request. In some examples, the diagnostic management computing module 210 receives the update periodically, or when an update is available. For example, the diagnostic management computing module 210 can check for the update daily (e.g., during hours when the user 250 is typically not utilizing the information handling system 202). For example, the diagnostic management computing module 210 can check for the update overnight (e.g., between 12-2 am).

In some examples, the server information handling system 204 can automatically provide the update, or in response to a request for the update from the diagnostic management computing module 210. In some examples, the server information handling system 204 provides the update periodically, or when an update is available. For example, the server information handling system 204 can check whether the diagnostic management computing module 210 requested the update daily (e.g., during hours when the user 250 is typically not utilizing the information handling system 202). For example, the server information handling system 204 can check whether the diagnostic management computing module 210 requested the update overnight (e.g., between 12-2 am).

In some examples, when the computing commodity 212 is the BIOS, the update to the computing commodity 212 is an update to a version of the BIOS. In some examples, when the computing commodity 212 is the OS, the update to the computing commodity 212 is an update to a version of the OS. In some examples, when the computing commodity 212 is computing hardware, the update to the computing hardware is an update to a driver of the computing hardware. In some examples, when the computing commodity 212 is a computer-executable application, the update is an update to a version of the computer-executable application. In some examples, when the computing commodity 212 is an external computing device, the update is an update to firmware of the external computing device.

The diagnostic management computing module 210 applies the update to the computing commodity 212, at 304. In some examples, the diagnostic management computing module 210 automatically updates the computing commodity 212 in response to receiving the update to the computing commodity 212. In some examples, the diagnostic management computing module 210 updates the computing commodity 212 without user input from the user 250. That is, the diagnostic management computing module 210 “auto-updates” the computing commodity 212 (in response to receiving the update).

In some examples, when the diagnostic management computing module 210 applies the update to the computing commodity 212, the update can cause the computing commodity 212 to malfunction, not function as intended, become unusable, have certain features broken/unusable, or the like. For example, the update can be an update to the BIOS of the information handling system 202, and can result in a broken functionality of a touchscreen of the information handling system 202. For example, the update can be an update to an audio driver, and can result in the audio glitching at the information handling system.

The diagnostic management computing module 210, in response to applying the update and without user input, identifies previous results of a previous diagnostic test performed at the computing commodity 212, at 306. Specifically, the diagnostic management computing module 210 accesses the storage device 214. The storage device 214 stores data related to previous results for previous diagnostic tests performed at the computing commodity 212. The diagnostic management computing module 210 can identify the previous diagnostic test that is closest in time to reception of the update to the computing commodity 212. The previous results can indicate if the computing commodity 212 passed or failed the previous diagnostic test, any regressions associated with the previous diagnostic test, and the like. The previous results can indicate if the computing commodity 212 and/or other computing software/hardware/firmware of the information handling system 202 passed or failed the previous diagnostic test that is appropriate for the computing commodity 212.

The diagnostic management computing module 210, further in response to applying the update, performs, after applying the update to the computing commodity 212, a current diagnostic test at the computing commodity 212, at 308. The current diagnostic test of the computing commodity 212 can generate current results that indicate if the computing commodity 212 passed or failed the current diagnostic test, any regressions associated with the current diagnostic test, and the like. The current results can indicate if the computing commodity 212 and/or other computing software/hardware/firmware of the information handling system 202 passed or failed the current diagnostic test that is appropriate for the computing commodity 212.

In some examples, the current diagnostic test for the computing commodity 212 is the same (or substantially the same) as the previous diagnostic test for the computing commodity 212.

For example, when the update is for the BIOS of the information handling system 202, the diagnostic management computing module 210 can perform a current diagnostic test of the BIOS and other related computing commodities to determine if they are working/functioning as intended. For example, when the update is for a driver of computing hardware, the diagnostic management computing module 210 can perform a current diagnostic test of the computing hardware to determine if the computing hardware is working/functioning as intended.

The diagnostic management computing module 210 can compare the current results of the current diagnostic test at the computing commodity 212 to the previous results of the previous diagnostic test at the computing commodity 212, at 310. In some examples, the diagnostic management computing module 210 can compare the current results to the previous results to determine if the current results match the previous results. For example, the diagnostic management computing module 210 can determine whether the previous results indicate that the computing commodity 212 passed or failed the previous diagnostic test by the diagnostic management computing module 210, and compare such passing or failing of the previous diagnostic test to the current results that indicate whether the computing commodity 212 passed or failed the current diagnostic test by the diagnostic management computing module 210.

The diagnostic management computing module 210 determines, based on the comparing, if the computing commodity 212 failed the current diagnostic test, at 312. Specifically, the diagnostic management computing module 210 determines if the computing commodity 212 failed the current diagnostic test based on the comparison of the current results with the previous results. In some examples, the diagnostic management computing module 210 determines, based on the comparing, that the computing commodity 212 failed the current diagnostic test (at 312). For example, the diagnostic management computing module 210 determines that the previous results of the previous diagnostic test indicate that the computing commodity 212 passed the previous diagnostic test, and the current results of the current diagnostic test indicate that the computing commodity 212 failed the current diagnostic test. Thus, the diagnostic management computing module 210 determines that since the previous results indicate a pass, and the current results indicate a fail, that the computing commodity 212 failed the current diagnostic test.

In response to determining that the computing commodity 212 failed the current diagnostic test, the diagnostic management computing module 210 performs, without user input by the user 250, a remediation action at the computing commodity 212, at 314. Specifically, the diagnostic management computing module 210 can perform automatic remediation actions at the computing commodity 212 in response to the failure of the current diagnostic test at the computing commodity 212. Such remediation actions can include, in short, a rollback to a previous version of the computing commodity 212 prior to the update, or a further update to the latest/current drivers of the computing commodity 212.

For example, the diagnostic management computing module 210, in response to determining that the computing commodity 212 failed the current diagnostic test, can perform the remediation action at the computing commodity 212 of reverting the BIOS to a previous version without input/interaction by the user 250. That is, the diagnostic management computing module 210 can revert, or facilitate reverting, the BIOS to a previous version automatically in response to determining that the computing commodity 212 failed the current diagnostic test.

For example, the diagnostic management computing module 210, in response to determining that the computing commodity 212 failed the current diagnostic test, can perform the remediation action at the computing commodity 212 of reverting the OS to a previous version without input/interaction by the user 250. That is, the diagnostic management computing module 210 can revert, or facilitate reverting, the OS to a previous version automatically in response to determining that the computing commodity 212 failed the current diagnostic test.

For example, the diagnostic management computing module 210, in response to determining that the computing commodity 212 failed the current diagnostic test, can perform the remediation action at the computing commodity 212 of reverting the driver of the computing hardware to a previous version without input/interaction by the user 250. That is, the diagnostic management computing module 210 can revert, or facilitate reverting, the driver of the computing hardware to a previous version automatically in response to determining that the computing commodity 212 failed the current diagnostic test.

For example, the diagnostic management computing module 210, in response to determining that the computing commodity 212 failed the current diagnostic test, can perform the remediation action at the computing commodity 212 of reverting the computer-executable application to a previous version without input/interaction by the user 250. That is, the diagnostic management computing module 210 can revert, or facilitate reverting, the computer-executable application to a previous version automatically in response to determining that the computing commodity 212 failed the current diagnostic test.

For example, the diagnostic management computing module 210, in response to determining that the computing commodity 212 failed the current diagnostic test, can perform the remediation action at the computing commodity 212 of reverting the firmware of the external computing device to a previous version without input/interaction by the user 250. That is, the diagnostic management computing module 210 can revert, or facilitate reverting, the firmware of the external computing device to a previous version automatically in response to determining that the computing commodity 212 failed the current diagnostic test.

The diagnostic management computing module 210 performs the remediation action independent of user action by a user 250 of the information handling system 202. That is, the diagnostic management computing module 210 performs the remediation action at the information handling system 202 (and specifically, at the computing commodity 212) automatically in response to determining that the computing commodity 212 failed the current diagnostic test. The diagnostic management computing module 210 can perform the remediation action (or remediation actions) to provide operability of the computing features of the computing commodity 212 by improving performance capabilities of the information handling system 202 (such as the computing commodity 212). That is, performing the remediation action(s) to the computing commodity 212 by the diagnostic management computing module 210 improves the performance capabilities of the information handling system 202 (the computing commodity 212) such that the functionality and the operability of the computing features of the computing commodity 212 is improved. In some examples, the diagnostic management computing module 210 can perform the remediation action (or remediation actions) to improve the performance capabilities of the information handling system 202 without user action/input by the user 250 (independent of user action/input by the user 250).

The diagnostic management computing module 210 performs, after performing the remediation action at the computing commodity 212, a further diagnostic test at the computing commodity 212, at 316. The further diagnostic test of the computing commodity 212 can generate further results that indicate if the computing commodity 212 passed or failed the further diagnostic test, any regressions associated with the further diagnostic test, and the like. The further results can indicate if the computing commodity 212 and/or other computing software/hardware/firmware of the information handling system 202 passed or failed the further diagnostic test that is appropriate for the computing commodity 212.

In some examples, the further diagnostic test for the computing commodity 212 is the same (or substantially the same) as the current diagnostic test for the computing commodity 212; and the further diagnostic test for the computing commodity 212 is the same (or substantially the same) as the previous diagnostic test for the computing commodity 212.

For example, when the update is for the BIOS of the information handling system 202, the diagnostic management computing module 210 can perform a further diagnostic test of the BIOS and other related computing commodities to determine if they are working/functioning as intended. For example, when the update is for a driver of computing hardware, the diagnostic management computing module 210 can perform a further diagnostic test of the computing hardware to determine if the computing hardware is working/functioning as intended.

The diagnostic management computing module 210 can compare the further results of the further diagnostic test at the computing commodity 212 to the previous results of the previous diagnostic test at the computing commodity 212, at 318. In some examples, the diagnostic management computing module 210 can compare the further results to the previous results to determine if the further results match the previous results. For example, the diagnostic management computing module 210 can determine whether the previous results indicate that the computing commodity 212 passed or failed the previous diagnostic test by the computing commodity 212, and compare such passing or failing of the previous diagnostic test to the further results that indicate whether the computing commodity 212 passed or failed the further diagnostic test by the computing commodity 212.

The diagnostic management computing module 210 determines, based on the comparing, if the computing commodity 212 failed the current diagnostic test, at 320. Specifically, the diagnostic management computing module 210 determines if the computing commodity 212 failed the further diagnostic test based on the comparison of the further results with the previous results. In some examples, the diagnostic management computing module 210 determines, based on the comparing, that the computing commodity 212 passed the further diagnostic test (at 320). For example, the diagnostic management computing module 210 determines that the previous results of the previous diagnostic test indicate that the computing commodity 212 passed the previous diagnostic test, and the further results of the further diagnostic test indicate that the computing commodity 212 passed the further diagnostic test. Thus, the diagnostic management computing module 210 determines that since the previous results indicate a pass, and the further results indicate a pass, that the computing commodity 212 passed the further diagnostic test.

In response to determining that the computing commodity 212 passed the further diagnostic test, the diagnostic management computing module 210 enables the computing commodity 212, at 322. For example, the OS, BIOS, the computing hardware, the external computing device, and/or computer-executable application can be enabled and fully functional at the information handling system 202. That is, the computing commodity 212 is fully enabled in response to the update being applied at the computing commodity 212.

Further in response to determining that the computing commodity 212 passed the further diagnostic test, the diagnostic management computing module 210 uploads to the server information handling system 202, a current state of the computing commodity 212 and the remediation action performed at the computing commodity 212, at 324. That is, the diagnostic management computing module 210 uploads to the server information handling system 202 the current state of the computing commodity 212 such as a current version of the computing commodity 212. Further, the diagnostic management computing module 210 uploads to the server information handling system 202 the remediation action performed that is associated with the current version of the computing commodity 212 such as rollback of the update to the previous version of the computing commodity 212, or application of a new driver at the computing commodity 212.

For example, when the computing commodity 212 is the BIOS, the diagnostic management computing module 210 uploads to the server information handling system 202 the current version of the BIOS, and the remediation action performed at the BIOS such as restoring the BIOS to the previous version from the update that was applied.

For example, when the computing commodity 212 is the OS, the diagnostic management computing module 210 uploads to the server information handling system 202 the current version of the OS, and the remediation action performed at the OS such as restoring the OS to the previous version from the update that was applied.

For example, when the computing commodity 212 is the computing hardware, the diagnostic management computing module 210 uploads to the server information handling system 202 the current version of the driver of the computing hardware, and the remediation action performed at the computing hardware such as restoring the driver to the previous version from the update that was applied.

For example, when the computing commodity 212 is the computer-executable application, the diagnostic management computing module 210 uploads to the server information handling system 202 the current version of the computer-executable application, and the remediation action performed at the computer-executable application such as restoring the computer-executable application to the previous version from the update that was applied.

For example, when the computing commodity 212 is the external computing device, the diagnostic management computing module 210 uploads to the server information handling system 202 the current version of the firmware of the external computing device, and the remediation action performed at the external computing device such as restoring the firmware to the previous version from the update that was applied.

In some examples, the diagnostic management computing module 210 determines, based on the comparing, that the computing commodity 212 failed the further diagnostic test (at 320), and in response, provides an error signal, at 326.

In some examples, the diagnostic management computing module 210 determines, based on the comparing, that the computing commodity 212 passed the current diagnostic test (at 312). For example, the diagnostic management computing module 210 determines that the previous results of the previous diagnostic test indicate that the computing commodity 212 passed the previous diagnostic test, and the current results of the current diagnostic test indicate that the computing commodity 212 passed the current diagnostic test. Thus, the diagnostic management computing module 210 determines that since the previous results indicate a pass, and the current results indicate a pass, that the computing commodity 212 failed the current diagnostic test. For example, the diagnostic management computing module 210 determines that the previous results of the previous diagnostic test indicate that the computing commodity 212 failed the previous diagnostic test, and the current results of the current diagnostic test indicate that the computing commodity 212 passed the current diagnostic test. Thus, the diagnostic management computing module 210 determines that since the previous results indicate a fail, and the current results indicate a pass, that the computing commodity 212 failed the current diagnostic test.

In response to determining that the computing commodity 212 passed the current diagnostic test, the diagnostic management computing module 210 enables the computing commodity 212, at 328, similar to that of step 322. Further in response to determining that the computing commodity 212 passed the further diagnostic test, the diagnostic management computing module 210 uploads to the server information handling system 202, a current state of the computing commodity 212 and the remediation action performed at the computing commodity, at 330, similar to that of step 324.

In some examples, when the diagnostic management computing module 210 determines, based on the comparing, that the computing commodity 212 failed the current diagnostic test (at 312), the diagnostic management computing module 210 determines that the previous results of the previous diagnostic test indicate that the computing commodity 212 failed the previous diagnostic test, and the current results of the current diagnostic test indicate that the computing commodity 212 failed the current diagnostic test. Thus, the diagnostic management computing module 210 determines that since the previous results indicate a fail, and the current results indicate a fail, the diagnostic management computing module 210 provides an error signal.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing proactive diagnostic operations at an information handling system, the method comprising:
receiving an update to a computing commodity of the information handling system;
applying the update to the computing commodity of the information handling system;
in response to applying the update and without user input:
identifying previous results of a previous diagnostic test performed at the computing commodity;
performing, after applying the update to the computing commodity, a current diagnostic test at the computing commodity;
comparing current results of the current diagnostic test at the computing commodity to the previous results of the previous diagnostic test at the computing commodity;
determining, based on the comparing, that the computing commodity failed the current diagnostic test, and in response:
performing, without user input, a remediation action at the computing commodity;
after performing the remediation action at the computing commodity, performing a further diagnostic test at the computing commodity;
comparing further results of the further diagnostic test at the computing commodity to the previous results of the previous diagnostic test at the computing commodity;
determining, based on the comparing, that the computing commodity passed the further diagnostic test, and in response:
enabling the computing commodity at the information handling system.

2. The computer-implemented method of claim 1, further including:
in response to determining that the computing commodity passed the further diagnostic test:
uploading, to a server information handling system, a current state of the computing commodity and the remediation action performed at the computing commodity.

3. The computer-implemented method of claim 1, wherein the previous diagnostic test, the current diagnostic test, and the further diagnostic test are the same diagnostic test.

4. The computer-implemented method of claim 1, wherein the computing commodity is the basic input/output system (BIOS) of the information handling system, wherein the update to the computing commodity is an update to a version of the BIOS, wherein performing the remediation action further includes reverting the BIOS to a previous version.

5. The computer-implemented method of claim 1, wherein the computing commodity is the operating system (OS) of the information handling system, wherein the update to the computing commodity is an update to a version of the OS, wherein performing the remediation action further includes reverting the OS to a previous version.

6. The computer-implemented method of claim 1, wherein the computing commodity is computing hardware of the information handling system, wherein the update to the computing commodity is an update to a driver of the computing hardware, wherein performing the remediation action further includes reverting the driver of the computing hardware to a previous version.

7. The computer-implemented method of claim 1, wherein the computing commodity is a computer-executable application of the information handling system, wherein the update to the computing commodity is an update to a version of the computer-executable application, wherein performing the remediation action further includes reverting the computer-executable application to a previous version.

8. The computer-implemented method of claim 1, wherein the computing commodity is an external computing device of the information handling system, wherein the update to the computing commodity is an update to firmware of the external computing device, wherein performing the remediation action further includes reverting the firmware to a previous version.

9. The computer-implemented method of claim 1, further including:
determining, based on the comparing, that the computing commodity passed the current diagnostic test, and in response:
enabling the computing commodity at the information handling system; and
uploading, to a server information handling system, a current state of the computing commodity.

10. An information handling system comprising a processor having access to memory media storing instructions executable by the processor to perform operations, comprising:
receiving an update to a computing commodity of the information handling system;
applying the update to the computing commodity of the information handling system;
in response to applying the update and without user input:
identifying previous results of a previous diagnostic test performed at the computing commodity;
performing, after applying the update to the computing commodity, a current diagnostic test at the computing commodity;
comparing current results of the current diagnostic test at the computing commodity to the previous results of the previous diagnostic test at the computing commodity;
determining, based on the comparing, that the computing commodity failed the current diagnostic test, and in response:
performing, without user input, a remediation action at the computing commodity;
after performing the remediation action at the computing commodity, performing a further diagnostic test at the computing commodity;
comparing further results of the further diagnostic test at the computing commodity to the previous results of the previous diagnostic test at the computing commodity;
determining, based on the comparing, that the computing commodity passed the further diagnostic test, and in response:
enabling the computing commodity at the information handling system.

11. The information handling system of claim 10, the operations further including:
in response to determining that the computing commodity passed the further diagnostic test:
uploading, to a server information handling system, a current state of the computing commodity and the remediation action performed at the computing commodity.

12. The information handling system of claim 10, wherein the previous diagnostic test, the current diagnostic test, and the further diagnostic test are the same diagnostic test.

13. The information handling system of claim 10, wherein the computing commodity is the basic input/output system (BIOS) of the information handling system, wherein the update to the computing commodity is an update to a version of the BIOS, wherein performing the remediation action further includes reverting the BIOS to a previous version.

14. The information handling system of claim 10, wherein the computing commodity is the operating system (OS) of the information handling system, wherein the update to the computing commodity is an update to a version of the OS, wherein performing the remediation action further includes reverting the OS to a previous version.

15. The information handling system of claim 10, wherein the computing commodity is computing hardware of the information handling system, wherein the update to the computing commodity is an update to a driver of the computing hardware, wherein performing the remediation action further includes reverting the driver of the computing hardware to a previous version.

16. The information handling system of claim 10, wherein the computing commodity is a computer-executable application of the information handling system, wherein the update to the computing commodity is an update to a version of the computer-executable application, wherein performing the remediation action further includes reverting the computer-executable application to a previous version.

17. The information handling system of claim 10, wherein the computing commodity is an external computing device of the information handling system, wherein the update to the computing commodity is an update to firmware of the external computing device, wherein performing the remediation action further includes reverting the firmware to a previous version.

18. The information handling system of claim 10, the operations further including:
determining, based on the comparing, that the computing commodity passed the current diagnostic test, and in response:
enabling the computing commodity at the information handling system; and
uploading, to a server information handling system, a current state of the computing commodity.

19. A non-transitory computer-readable medium storing software comprising instructions executable by one or more computers which, upon such execution, cause the one or more computers to perform operations comprising:
receiving an update to a computing commodity of the information handling system;
applying the update to the computing commodity of the information handling system;
in response to applying the update and without user input:
identifying previous results of a previous diagnostic test performed at the computing commodity;
performing, after applying the update to the computing commodity, a current diagnostic test at the computing commodity;
comparing current results of the current diagnostic test at the computing commodity to the previous results of the previous diagnostic test at the computing commodity;
determining, based on the comparing, that the computing commodity failed the current diagnostic test, and in response:
performing, without user input, a remediation action at the computing commodity;
after performing the remediation action at the computing commodity, performing a further diagnostic test at the computing commodity;
comparing further results of the further diagnostic test at the computing commodity to the previous results of the previous diagnostic test at the computing commodity;
determining, based on the comparing, that the computing commodity passed the further diagnostic test, and in response:
enabling the computing commodity at the information handling system.

20. The non-transitory computer-readable medium of claim 19, the operations further including:
in response to determining that the computing commodity passed the further diagnostic test:
uploading, to a server information handling system, a current state of the computing commodity and the remediation action performed at the computing commodity.
